(19) United States
(12) Patent Application Publication
(10) Pub. No.: US 2012/0073193 A1
(43) Pub. Date: Mar. 29, 2012

(54) Reconfigurable Support System, Apparatus, and Method Thereof

(76) Inventor: Scott J. Duplantis, Evans, GA (US)

(21) Appl. No.: 13/213,341

(22) Filed: Aug. 19, 2011

Related U.S. Application Data
(60) Provisional application No. 61/375,147, filed on Aug. 19, 2010.

(51) Int. Cl. A01G 17/06; A01G 1/00

(52) U.S. Cl. 47/45; 47/44; 47/58.1 R

(57) ABSTRACT

Configurable, reconfigurable, and/or adjustable systems, apparatuses, and methods to support plants, such as tomatoes, peppers, and beans. A support apparatus, an attachment element, and one or more support attachments may be provided. The support apparatus can be affixed to a planting pole, pipe, or stake, for example. The attachment element, which can be a screw, can be used to secure the support apparatus to the pole, pipe, or stake at a desired location. One or more of the support attachments can be physically coupled to the support apparatus. The support attachments can be reconfigured on the support apparatus. Thus, various support attachment configurations and/or reconfigurations can be made.

### CROSS-REFERENCE TO RELATED APPLICATION

This application claims the benefit of priority to U.S. Provisional Patent Application No. 61/375,147 filed Aug. 19, 2010, the entire content of which is hereby incorporated by reference into the present application.

### FIELD

The disclosed subject matter relates to systems, apparatuses, and methods for supporting one or more plants, such as tomato plants, pepper plants, bean plants, trees, bushes, shrubs, etc. In particular, the disclosed subject matter relates to reconfigurable and/or adjustable support systems, apparatuses, and methods for supporting one or more plants.

### SUMMARY

Various disclosed embodiments (i.e., one, some, or all) involve a support collar for supporting a plant comprising: an annular body having an outer circumference in plan view and defining a hollow inner portion; a receiving portion to receive an attachment element; a plurality of apertures extending through the annular body, from a top side to a bottom side thereof; and a plurality of boss elements, each said boss element being associated with a respective one of said apertures and configured to restrict at least lateral movement of a portion of a support attachment when the support attachment is inserted in the associated aperture. Optionally, the outer circumference of the annular body is generally circular in plan view, and the hollow inner portion is circular in shape in the plan view. Alternatively, the outer circumference of the annular body is generally square shape in plan view, and the hollow inner portion is circular in shape in the plan view. In various embodiments, each said boss element substantially prevents lateral movement of the portion of the support attachment when the support attachment is fully seated. In various embodiments, the annular body has a flange portion extending from hollow inner portion to the outer circumference, the flange portion being formed at an angle with respect to a horizontal plane perpendicular to an imaginary longitudinal center axis of the annular body. Optionally, the angle is an acute angle. Alternatively, the angle is zero. In various embodiments, each said boss element is one of U-shape, V-shape, digital U-shape, or two spaced-apart I shape members in plan view. In various embodiments, each said boss element is recessed in the annular body. Optionally, the aperture/boss element combinations are arranged radially about the annular body.

Various embodiments also can include a reconfigurable system for supporting a plant comprising: means for supporting at least one plant; means for receiving said means for supporting; and means for coupling said means for receiving to one of a planting stake, a planting pole, and a planting pipe. In various embodiments, said means for supporting includes at least one of a wire, a zip tie, twine, multiple wires, a strap, and a string. In various embodiments, the system is reconfigurable, reconfigurable including at least one of movement of said means for receiving along a length of the planting stake, a planting pole, and a planting pipe and a different configuration of said means for supporting at least one plant. In various embodiments, said means for supporting at least one plant includes a plurality of individual support members. Optionally, the system can further comprise means for restricting or inhibiting movement of said means for supporting at least one plant. In various embodiments, said receiving said means for supporting includes: means for receiving said means for coupling; a plurality of apertures extending in a thickness direction thereof; and means for restricting or inhibiting movement of said means for supporting at least one plant. Optionally the system can further comprise means for changing an inner volume or diameter of said means for receiving said means for supporting.

Various embodiments can also include a method for supporting a plant comprising: providing an annular collar; providing an attachment element, the attachment element coupling the annular collar to one of a planting stake, a planting pole, and a planting pipe; and providing at least support attachment, said providing including physically configuring the annular collar with at least one support attachment. Optionally the method can further comprise physically reconfiguring the annular collar with one or more support attachments. In various embodiments, said physically reconfiguring the annular collar is with one or more support attachments different from said at least one support attachment of said physically configuring.

### BRIEF DESCRIPTION OF THE DRAWINGS

The accompanying drawings illustrate embodiments of the disclosed subject matter. The disclosed subject matter will be best understood by reading the ensuing specification in conjunction with the drawing figures, in which like elements are designated by like reference numerals, and wherein:

FIGS. 1A and 1B are conceptual drawings of a reconfigurable support system according to various embodiments of the disclosed subject matter.

FIG, 2 is a perspective view of a support apparatus according to various embodiments of the disclosed subject matter.

FIGS. 3A, 3B, 3C, 3D, and 3E are overhead, front, underneath, perspective, and cross-sectional views, respectively, of the support apparatus of FIG. 2.

FIG. 4A is an exploded perspective view of the support apparatus shown in FIG. 2 with an insert element and an attachment element according to various embodiments of the disclosed subject matter.

FIG. 4B is a cross-sectional view of the support apparatus shown in FIG. 4A with insert and attachment elements.

FIGS. 5A, 5B, and 5C are examples of support attachments for use with support apparatuses according to various embodiments of the disclosed subject matter, such as the support apparatus shown in FIG. 2.

FIG. 6 is a cross section view of the support apparatus shown in FIG. 2 with a support attachment coupled thereto, such as one of the support attachments shown in FIGS. 5A, 5B, and 5C.

FIGS. 7A and 7B are overhead perspective and slightly below, side perspective views, respectively, of the support apparatus shown in FIG. 2 configured with support attachments, such as the support attachment shown in either FIG. 5A or FIG. 5B, and with an attachment element, such as the attachment element shown in FIGS. 4A and 4B.

FIG. 8 is an overhead perspective view of the support apparatus shown in FIG. 2 configured with support attachments, such as that shown in either FIG. 5A or FIG. 5B, and with an attachment element, such as that shown in FIGS. 4A and 4B.

FIG. 9 is an overhead perspective view of the support apparatus shown in FIG. 2 configured with support attachments, such as the support attachment shown in FIG. 5C, and with an attachment element, such as that shown in FIGS. 4A and 4B.

FIG. 10 is an overhead perspective view of the support apparatus shown in FIG. 2 configured with a variety of support attachments, such as those shown in FIGS. 5A, 5B, and 5C, and with an attachment element, such as that shown in FIGS. 4A and 4B.

FIG. 11 is an overhead perspective view of the support apparatus shown in FIG. 2 configured with alternative support attachments according to various embodiments of the disclosed subject matter.

FIG. 12A is an overhead perspective view of the support apparatus shown in FIG. 2 configured with support attachments according to various embodiments of the disclosed subject matter.

FIG. 12B is an overhead, exploded view of the support apparatus and support attachment configuration shown in FIG. 12A.

FIGS. 13A and 13B are overhead perspective and overhead exploded views, respectively, of the support apparatus shown in FIG. 2 configured with support attachments similar to the configuration of FIGS. 12A and 12B, but with retaining elements at connection points between adjacent support attachments.

FIG. 14A shows the support apparatus of FIG. 2 coupled to a pole by an attachment element and configured with support attachments, such as those shown in FIGS. 5A and 5B.

FIG. 14B is an enlarged portion of FIG. 14A showing the support apparatus of FIG. 2 coupled to the pole.

FIGS. 15A, 15B, 150, 15D, and 15E are overhead, front, bottom, perspective, and side views, respectively, of a support apparatus similar to the support apparatus shown in FIG. 2, according to various embodiments of the disclosed subject matter.

FIGS. 16A, 16B, 16C, 16D, and 16E are overhead, back, bottom, perspective, and side views, respectively, of a support apparatus of generally square shape in plan view according to various embodiments of the disclosed subject matter.

FIGS. 17A, 17B, 17C, 17D, 17E, and 17F are cross-sectional, front, side, back, perspective, and end views, respectively, of a support apparatus according to various embodiments of the disclosed subject matter.

FIG. 17G is a perspective view of a support system according to various embodiments of the disclosed subject matter comprised of the support apparatus of FIGS. 17A through 17F configured with support attachments and an attachment element.

FIGS. 18A and 18B are front and back perspective views of a support apparatus and attachment element according to various embodiments of the disclosed subject matter, similar to that of FIGS. 17A through 17F, but without a third elongate bottom aperture.

FIG. 18C is a support system according to various embodiments of the disclosed subject matter comprised of the support apparatus of FIGS. 18A and 18B configured with support attachments and mechanically coupled to a pole by an attachment element.

FIGS. 19A, 19B, 19C, 19D, and 19E are side, back, cross-sectional, end, and perspective views, respectively, of a support apparatus according to various embodiments of the disclosed subject matter.

FIG. 19F is a perspective view of a support system according to various embodiments of the disclosed subject matter comprised of the support apparatus of FIGS. 19A through 19E configured with a support attachment and an attachment element.

FIG. 20 is a flow chart of a method according to various embodiments of the disclosed subject matter.

FIG. 21A is an underneath exploded view of a support apparatus and collet according to various embodiments of the disclosed subject matter.

FIG. 21B is an underneath view of the support apparatus collet shown in FIG. 21A.

FIGS. 22A, 22B, 22C, and 22D are overhead, side, underneath, and perspective views, respectively, of a support apparatus according to embodiments of the disclosed subject matter.

FIGS. 23A, 23B, 23C, and 23D are perspective, side, overhead, and cross-sectional view, respectively, of the support apparatus shown in FIGS. 22A-22D with an insert element and attaching element according to embodiments of the disclosed subject matter.

FIG. 24 shows the support apparatus of FIGS. 22A-22D coupled to a pole and configured with support attachments.

### DETAILED DESCRIPTION

Various embodiments of the disclosed subject matter involve configurable, reconfigurable, and/or adjustable systems, apparatuses, and methods to support stems, for example, of a variety of plants, such as tomatoes, peppers, and beans. The disclosed subject matter can be used to support both in-ground and container-held plants and may eliminate the use of cages, such as “tomato” cages. Various embodiments of the disclosed subject matter may allow a plant to be staked at its center and its stems to be more evenly spaced, which may be especially useful in container gardening. Furthermore, various embodiments of the disclosed subject matter can “grow” with the plant by being adjusted so as to move upward along a planting pole, pipe, or stake in correspondence with growth of the plant upward. Various embodiments of the disclosed subject matter also may be used with an upside-down planter, wherein hanging stems or branches can be supported such that each stem or branch is spread out from one or more other stems or branches.

Generally speaking, various embodiments of the disclosed subject matter can be configured or reconfigured to provide a maximum range of support of 360 degrees. Of course the range or amount of support may be configured or reconfigured to be less than the aforementioned maximum amount. Optionally, in various embodiments, the range of support can be continuous. Alternatively, the range of support may be discontinuous or segmented, for example, with portions of support separated by respective portions of non-support.

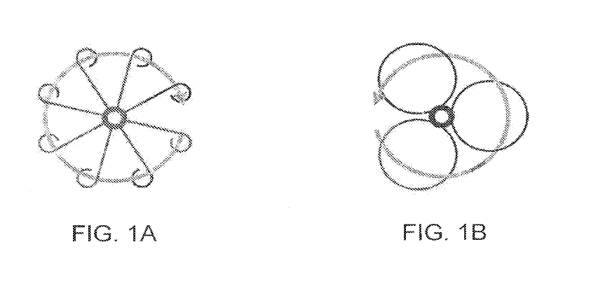

One support attachment or a variety of support attachments can be used to provide the maximum range of support or any suitable amount of support below the maximum amount. Furthermore, configuration and/or reconfiguration can be customized by mixing, matching, and/or omitting support attachments. FIGS. 1A and 1B show the concept of providing degrees of support according to various embodiments of the disclosed subject matter, whereby two different configurations of support attachments are shown, each configuration providing 360 degrees of support. Support attachments can be of any suitable support attachments, such as a wire or wires, a string, twine, zip ties, a strap, etc.

In general, a support system 100 according to various embodiments of the disclosed subject matter can include a support apparatus, an attachment element, and one or more support attachments. Optionally the support system 100 can include an insert element, which may be used to adapt the support apparatus to a different size or shape of pole, stake, or pipe. Support apparatuses according to various embodiments of the disclosed subject matter can be of any suitable material, such as plastic, metal, elastomers, etc., and can be made by any suitable process, such as injection molding, die casting, etc.

A kit may be provided with one or more support apparatuses of same or different configurations (e.g., same or different size, shape, layout, etc.), at least a same number of attachment elements as support apparatuses, and a plurality of support attachments. Optionally, one or more insert elements may be provided in the kit. In various embodiments, the plurality of support attachments can all be of the same configuration, or some can be of the same configuration, or all can be different configurations. Thus, with one kit, any suitable number of support system 100 configurations and/or reconfigurations can be made by mixing, matching, and/or leaving out support attachments when configuring each support apparatus with support attachments. In various embodiments, a kit may further include one or more poles, stakes, and/or pipes. Furthermore, a kit may include only one or more collars and at least a same number of attachment elements as support apparatuses, or a kit may include only support attachments. Essentially any suitable type and combination of elements (or omission of elements) may be provided in a kit according to various embodiments of the disclosed subject matter.

Support apparatuses according to various embodiments of the disclosed subject matter can take any suitable shape, can be of any suitable size, and can be of any suitable configuration.

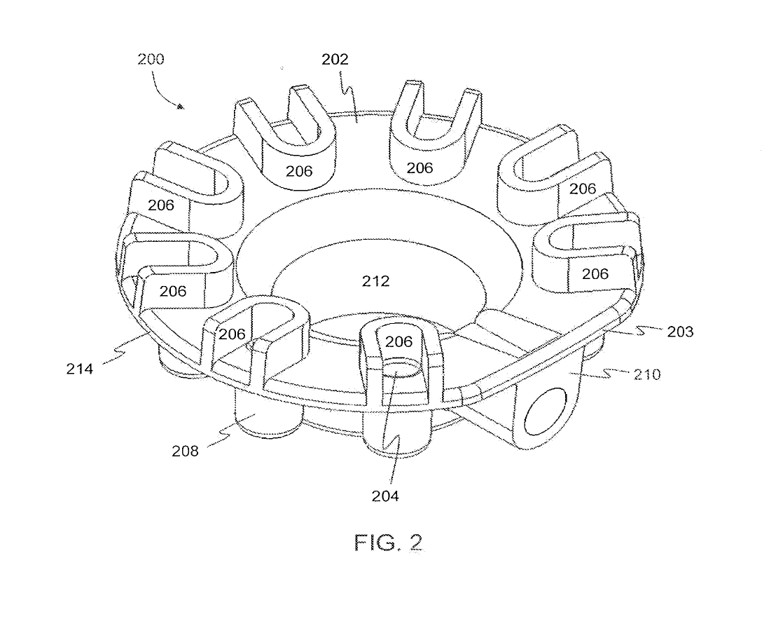

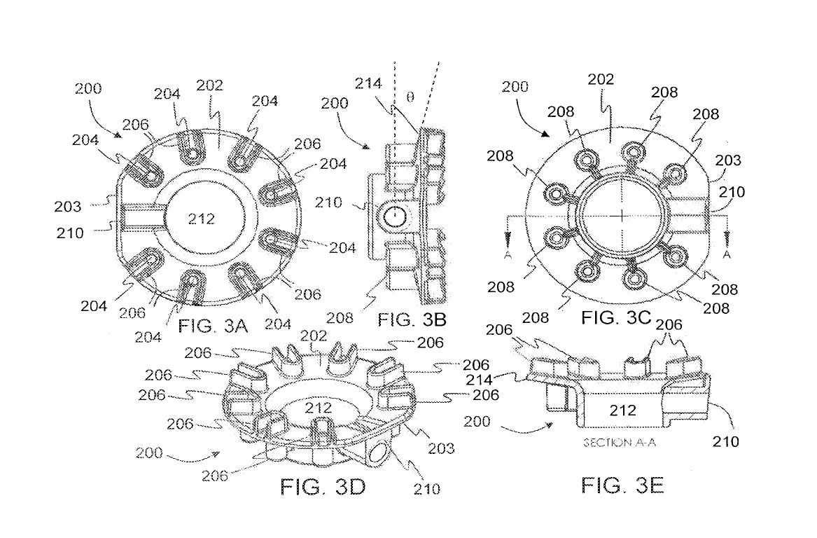

FIGS. 2 and 3A through 3E show a support apparatus according to various embodiments of the disclosed subject matter.

The support apparatus shown in FIGS. 2 and 3A through 3E is in the form of a collar 200. Collar 200 can have an annular body 202 with a circular or generally circular outer perimeter or circumference in plan view. Optionally, a flat portion 203 in plan view may be provided. Flat portion 203 may facilitate access to a receiving portion 210 configured to receive an attachment element according to various embodiments of the disclosed subject matter. Optionally, flat portion 203 may also facilitate access to the attachment element itself (e.g., it may facilitate removal and/or installation of the attachment element). Annular body 202 also may have an open portion 212, which can take any suitable shape in plan view, such as circular, square, rectangle, oval, etc. In various embodiments, the shape of open portion 212 may correspond to a shape of a pole, stake, or pipe to which the support apparatus is to be coupled. Furthermore, optionally, a portion of annular body 202 surrounding open portion may be at an angle or taper from a top to a bottom of annular body 202 or vice versa. Alternatively, in various embodiments, a portion of the annular body 202 surrounding open portion 212 may be threaded.

The annular body 202 of collar 200 also can have a flange portion 214 extending from open portion 212 to the outer perimeter or circumference of the annular body 202. In various embodiments, flange portion 214 may be formed at an angle θ with respect to a horizontal plane perpendicular to an imaginary longitudinal center axis of open portion 212, for example, in order to support or stabilize support attachments that are mechanically attached or coupled to the collar 200. Angle θ can be any suitable angle. In various embodiments, optionally, angle θ can be determined based on a configuration of one or more support attachments to be mechanically attached or coupled to the collar 200.

Annular body 202 can have a plurality of apertures 204 formed therein. In various embodiments, apertures 204 can be receptacles for removably coupling support attachments to collar 200 according to various embodiments of the disclosed subject matter. Support attachments may be retained in respective apertures 204 by friction and gravity and/or by being passed through the aperture and tied thereto (e.g., in the case of a tie string as a support attachment).

In various embodiments, each of the apertures 204 can extend through the annular body 202 in a direction parallel to the imaginary longitudinal center axis of open portion 212. Optionally, annular body 202 can also include a plurality of first boss members 208 (FIGS. 2 and 3A through 3E show cylindrical boss members, but the first boss members can be of any suitable shape) in correspondence with respective apertures 204. First boss members 208 can provide support and/or stability for support attachments placed therein. Optionally or alternatively, one, some, or all of the apertures 204 can extend through the annular body 202 at a non-parallel angle or at different non-parallel angles to the imaginary longitudinal center axis of open portion 212 (not shown in FIGS. 2 and 3A through 3E). In various embodiments, all of the apertures 204 can be at the same non-parallel angle. Alternatively, all of the apertures 204 may be at different angles, or some of the apertures 204 may be at the same angle. The orientation of the apertures 204 in the annular body 202 may be based on a configuration of the support attachments to be mechanically attached or coupled to the collar 200. Furthermore, the orientation of the apertures 204 may provide support or stabilization for support attachments that are mechanically attached or coupled to collar 200.

Apertures 204 can be of any suitable number, of any suitable shape and/or size, and of any suitable arrangement about annular body 202. FIGS. 2 and 3A through 3E, for example, show eight cylindrical apertures 204, radially arranged about annular body 202. An equal distance between some or all adjacent apertures 204 may be provided in various embodiments. Furthermore, apertures 204 may be arranged about annular body 202 to provide a configurable or reconfigurable range of support, such as 360 degrees.

In various embodiments, annular body 202 can have formed therein or thereon a plurality of second boss members 206. Second boss members 206 can be integral with or formed in one piece with annular body 202. Optionally or alternatively, second boss members 206 may be individual components that are fixedly coupled to annular body 202. In various embodiments, each second boss member 206 can correspond to a respective aperture 204, such as shown in FIGS. 2 and 3A through 3E.

Second boss members 206 can be of any suitable configuration. Second boss members 206 shown in FIGS. 2 and 3A through 3E, for example, are U-shaped ribs, extending upward from annular body 202 above an upper extremity of corresponding apertures 204. Alternatively, second boss members 206 may be V-shaped, digital U-shaped, or two spaced-apart I shaped members, for example. Furthermore, alternatively, in various embodiments, second boss members 206 may be troughs or the like recessed in annular body 202, extending from corresponding apertures 204, for example, to the outer circumference of the annular body 202.

In general, second boss members 206 may support and/or stabilize support attachments placed therein. For example, each U-shaped rib shown in FIGS. 2 and 3A through 3E may prevent or substantially prevent pivoting of a support attachment placed therein. Optionally or alternatively, second boss members 206 may limit an amount of pivoting of or other unwanted or undesirable movement of corresponding support attachments.

As noted above, in various embodiments, support attachments may be retained in respective apertures 204 by friction and gravity. Though not shown, individual caps, covers, or push nuts, for example, may be placed over individual second boss members 206 in order to prevent support attachments from being removed from their corresponding second boss members 206. Individual caps or covers may be coupled to their respective second boss members 206, for example, by a hinge or tether. Alternatively, a single cap or cover may be provided to cover all of the second boss members 206 to prevent all support attachments from being removed from their corresponding second boss members 206. The single cap or cover also may be coupled to the collar 200 by either a tether or a hinge, for example. In various embodiments, each support attachment also may be retained in the apertures 204 and/or second boss members 206 from an underside of the collar 200 by a cap or washer or the like, for example, placed on an end of the support attachment protruding from the aperture 204 and first boss 208, on an underside of the collar 200.

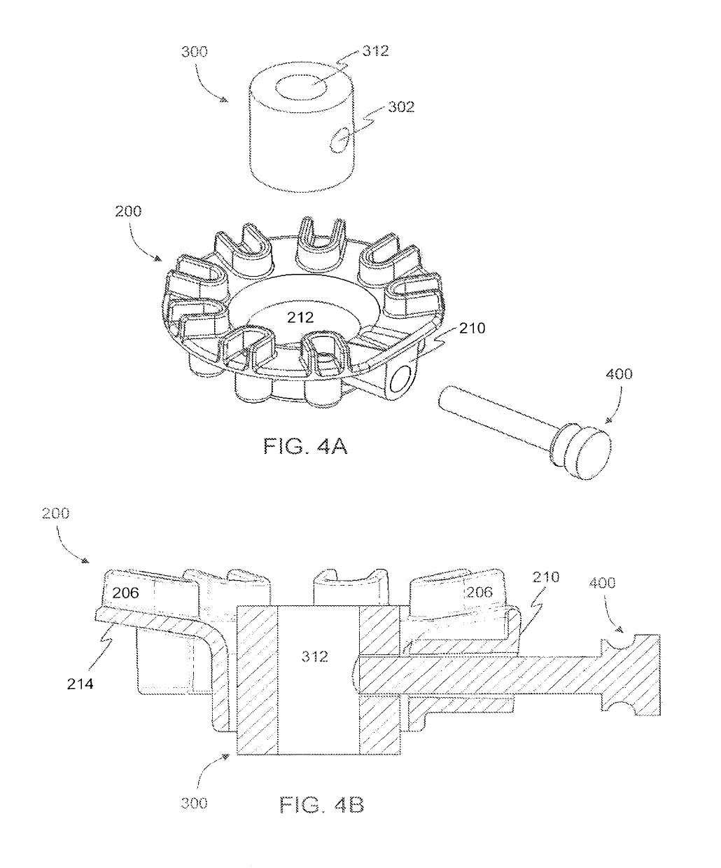

In various embodiments, collar 200 can include a receiving portion 210. Receiving portion 210 can be provided to receive an attachment element 400 for physically coupling the collar 200 to a planting pole, stake, or pipe, for example. FIGS. 4A and 4B show an example of an attachment element 400 in the form of a screw, which can be of any suitable configuration, such as a thumb screw (threads not explicitly shown).

Receiving portion 210 can be of any suitable configuration. In various embodiments, receiving portion 210 can be configured based on a configuration of an attachment element 400 to be received. For example, receiving portion 210 may be threaded (not explicitly shown in the figures) to receive a screw and to allow the screw to be threaded to extend into open portion 212 to change a volume of the open portion. Such changing of volume of the open portion 212 can be performed in order to “fit” the collar 200 to different sizes of planting poles, pipes, or stakes. Another example of a configuration of the receiving portion 210 includes a plurality of notches linearly arranged along a length of the inner cavity thereof, for example, to receive a corresponding depressible notch of attachment element 400 in order to set the attachment element 400 at different positions in the receiving portion 210 and/or in the open portion 212. Conversely, an attachment element 400 according to various embodiments of the disclosed subject matter can be configured based on the configuration of the receiving portion 210.

The inner portion of collar 200 (i.e., the outer portion of the open portion 212) can be of any shape, size, and/or configuration. For example, the size (e.g., diameter), shape, and/or configuration can be based on a size, shape, and/or configuration of a pole, pipe, or stake to which the collar 200 is to be mechanically coupled. The inner portion of collar 200 can run parallel to a central longitudinal axis of the inner portion, or, optionally, it can be angled, tapered, or some combination of parallel and non-parallel portions. In various embodiments the inner portion of collar 200 can be angled (e.g., either tapered from top to bottom or vice versa) so that the collar 200 can be removed from a molding tool.

Optionally, in various embodiments, an insert element 300 may be provided in order to effectively change an inner diameter or volume of collar 200 to an inner volume 312 of the insert element 300, for example, in order to fit different sizes of pipes, poles, or stakes. Insert element 300 can be of any suitable configuration and of any suitable size and/or shape. FIGS. 4A and 4B, for example show a cylindrical insert 300 having a cylindrical inner volume 312 and with an opening 302 that is to be lined up with an opening of the receiving portion 201 when the insert element 300 is inserted into the open portion 212 of the collar 200. Alternatively, insert element 300 may have an inner volume 312 that is of a shape other than cylindrical, such as a square shaped inner volume to fit a square shaped pole, stake, or pipe.

As alluded to above, one or more annular collars 200 can be secured to a variety of plant pipes, poles, and/or stakes, for example. In various embodiments, the annular collar 200 can be secured to a plant pipe, pole, or state using an attachment element 400, such as a screw. Optionally or alternatively, the annular collar 200 may rest at an appropriate height, based on its inner diameter, along a pipe, a pole, or a stake having a width or diameter that increases from top to bottom. Thus, in the aforementioned embodiment, an attachment element as shown and described with respect to item 400 in FIGS. 4A and 4B may not be necessary for the collar to be “held” in place. Alternatively, the plant pipe, pole, or stake may be itself threaded and the annular collar 200 may have a threaded inner portion for mating with the threads of the pipe, pole, or stake. Thus, the annular collar 200 in this particular embodiment can be threaded upward and/or downward along a length of the pipe, pole, or stake in order to adjust a height at which the collar 200 rests. A locking mechanism also may be implemented to lock the collar 200 at a particular position on the threaded pipe, pole, or stake.

One or more support attachments can be coupled to the support apparatus 200 and can extend generally radially outward from the support apparatus 200. The one or more support attachments can provide support for an associated plant or plants in proximity thereto. Optionally, some or all of the support attachments can provide support by allowing various parts of the plant to rest or lean thereon. Optionally or alternatively, some or all of the support attachments can be coupled to parts of the plants, such as the stems.

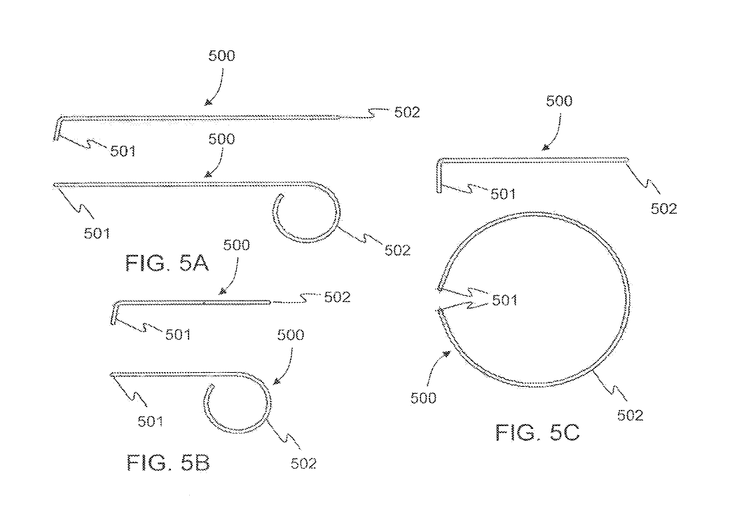

FIGS. 5A, 5B, and 5C show side and overhead examples of support attachments 500 for attaching to support apparatuses according to various embodiments of the disclosed subject matter, such as the support apparatus 200 shown in FIG. 2. Support attachments according to various embodiments of the disclosed subject matter can be of any suitable size and/or shape. Furthermore, support attachments can be of any suitable material. In various embodiments, the support attachments may be of a material or coated with a material that is corrosion resistance or prevents corrosion.

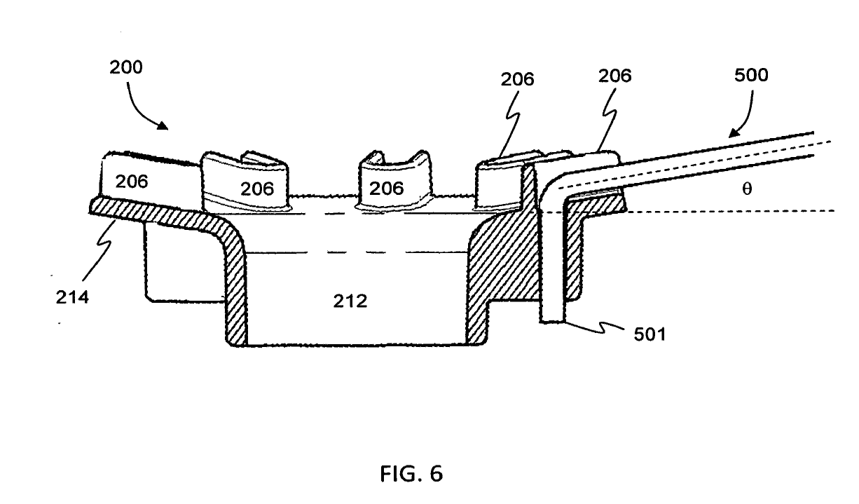

Each of the support attachments 500 has a first end 501 and a second end 502. First ends 501 can be inserted into apertures of support apparatuses according to various embodiments of the disclosed subject matter, such as apertures 204 in support apparatus 200. FIG. 6 is a cross-sectional view of the support apparatus 200 shown in FIG. 2 with a support attachment 500 coupled thereto. As can be seen from FIG. 6, first end 501 of the support attachment 500 can be inserted into aperture 204 such that the first end 501 projects from an underside of support apparatus 200, through first boss 208. As indicated earlier, optionally, support attachment 500 may be retained in the aperture 204 and/or boss members 206 from an underside of the support apparatus 200 by a cap, a washer, a push nut, or the like, for example, placed on the first end 501 of the support attachment 500 (not explicitly shown). Since flange 214 of support apparatus 200 can be formed at an angle θ with respect to a horizontal plane perpendicular to an imaginary longitudinal center axis of open portion 212, the corresponding support attachment 500 may also be at the angle θ. Such angling of the support attachment 500 can be to provide support for a plant or plant to be supported.

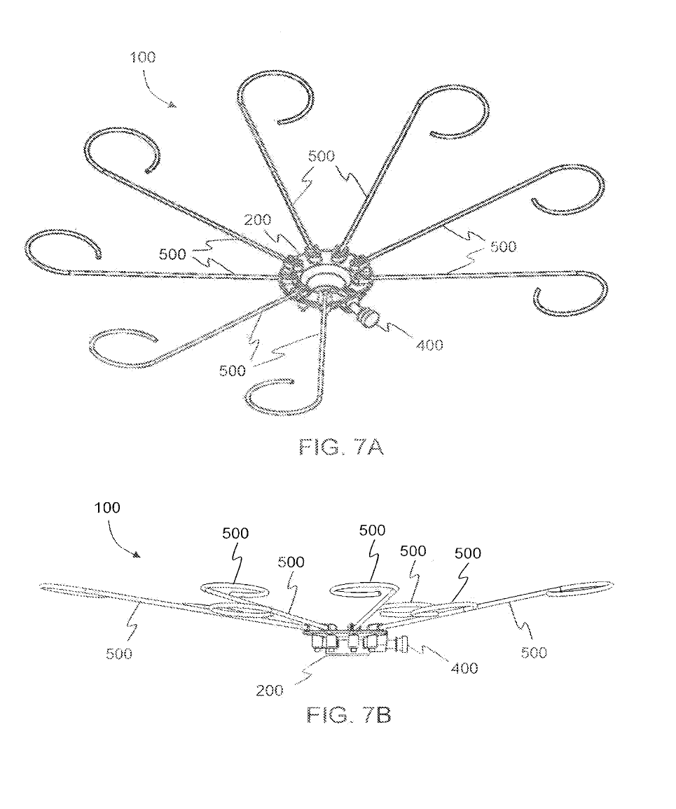

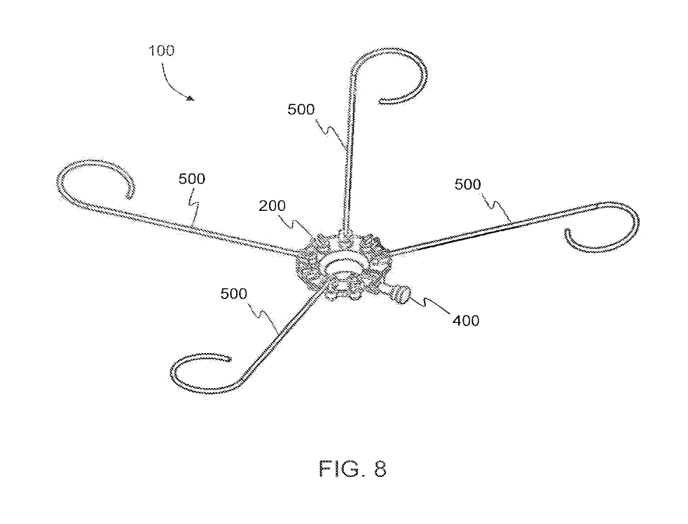

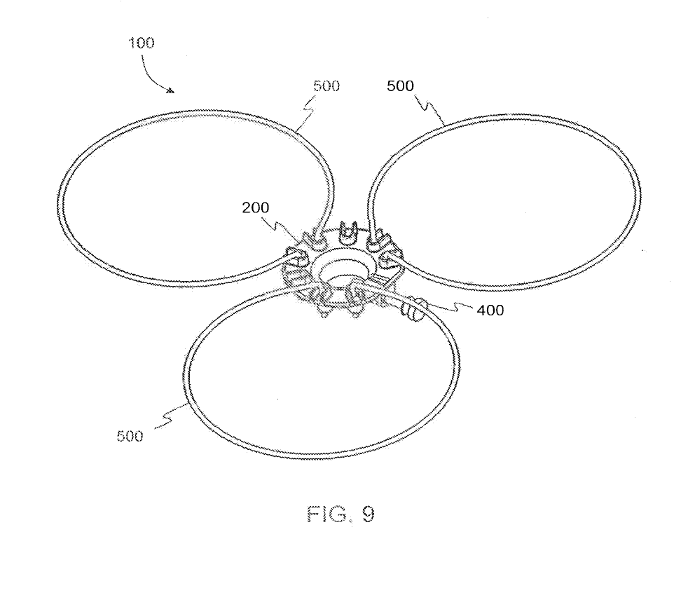

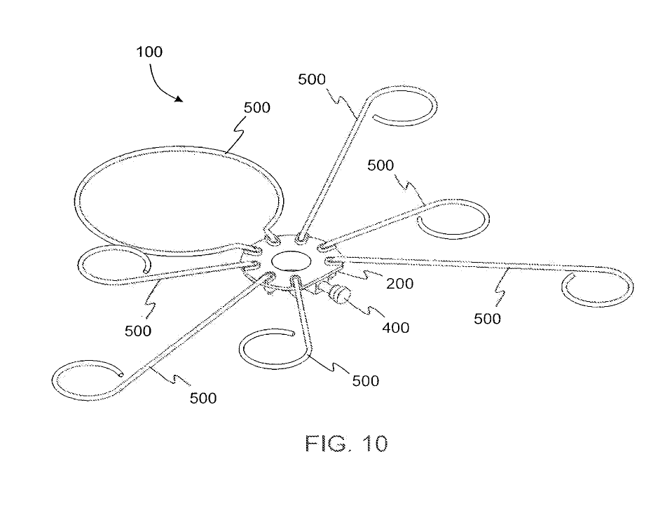

The support attachments 500 shown in FIGS. 5A through 5C can be coupled to support apparatus 200 in any suitable configuration and/or number. FIGS. 7A, 7 B, 8, and 9 respectively show a reconfigurable support system 100 with different configurations of support attachments 500 for support apparatus 200. The different configurations of support attachments 500 shown in FIGS. 7A, 7B, 8, and 9 are by no means the only configurations possible, and any suitable configuration of support attachments 500 and/or other support attachments can be implemented. FIG. 10, for example, shows reconfigurable support system 100 having a mixture of support attachments 500 from FIGS. 5A through 5C.

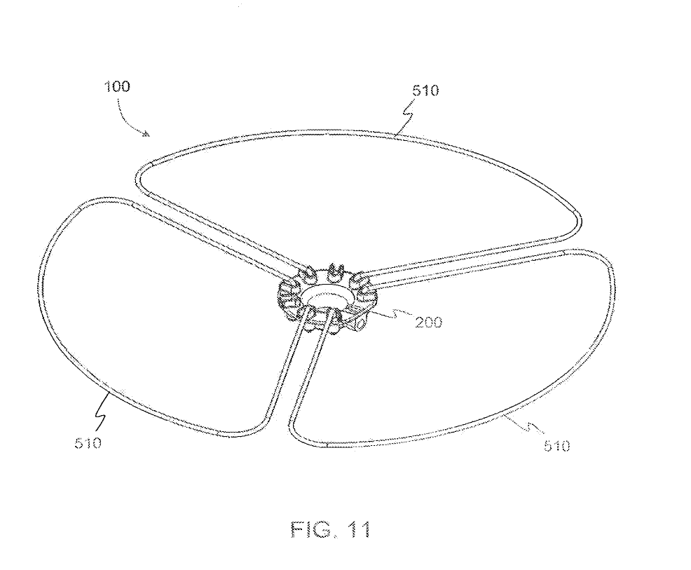

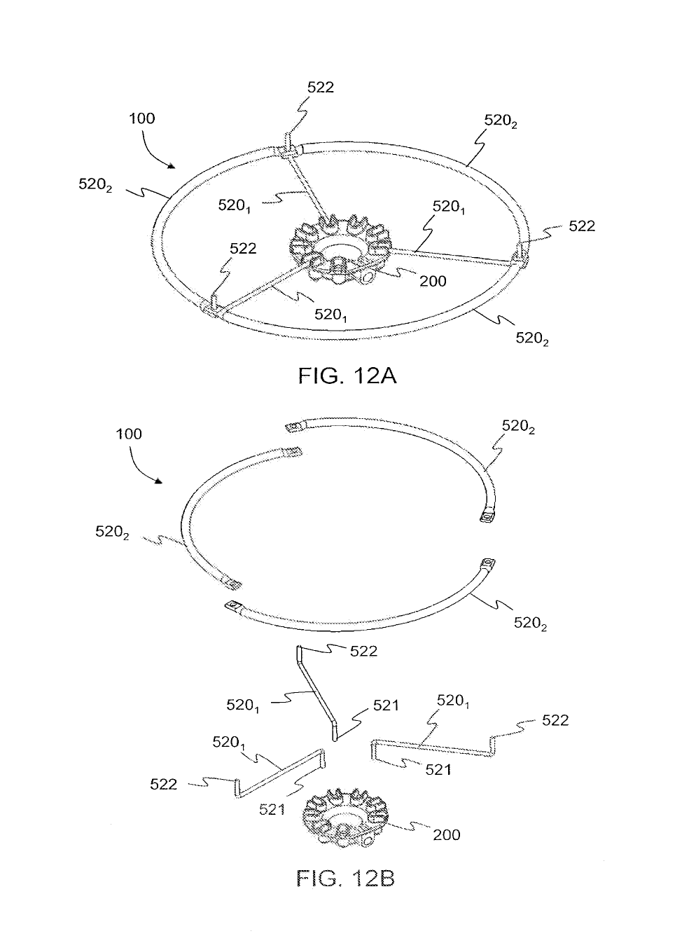

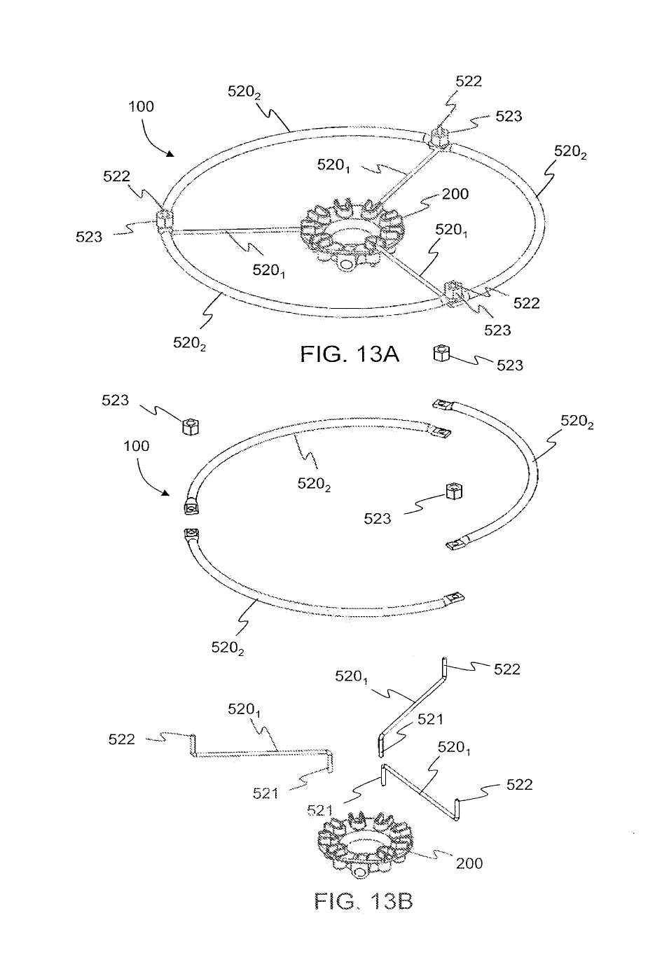

FIGS. 11, 12A, 12B, 13A, and 13B show other configurations of support apparatus 200 using support attachments different from those shown in FIGS. 5A through 5C. In particular, FIG. 11 is an overhead perspective view of the support apparatus 200 shown in FIG. 2 configured with alternative support attachments 510 according to various embodiments of the disclosed subject matter. FIG. 12A and 12B are overhead perspective and exploded views, respectively, of support apparatus 200 shown in FIG. 2 configured with support attachment member portions 520₁, 520₂ according to various embodiments of the disclosed subject matter. As can be seen in FIG. 12A, adjacent support member portions 520₂ can be arranged in overlapping fashion on a respective second ends 522 of support attachment member portions 520₁. FIGS. 13A and 13B are overhead perspective and overhead exploded views, respectively, of support apparatus 200 configured with support member portions 520₁, 520₂ similar to the configuration of FIGS. 12A and 12B, but with retainers 523 at connection points between adjacent support member portions 520₂. Retainers 523 can be any suitable retainer, such as a threaded nut that can be threaded onto threads of second ends 522. Note that second ends 522 may be, but are not required to be threaded. For example, in various embodiments retainers 523 may be caps and can be placed or snapped onto respective second ends 522. As with the configurations discussed above, the configurations shown in FIGS. 11, 12A, 12B, 13A, and 13B are merely examples. Optionally, attachment member portions 520₁, 520₂ may be formed in one piece (e.g., by welding together).

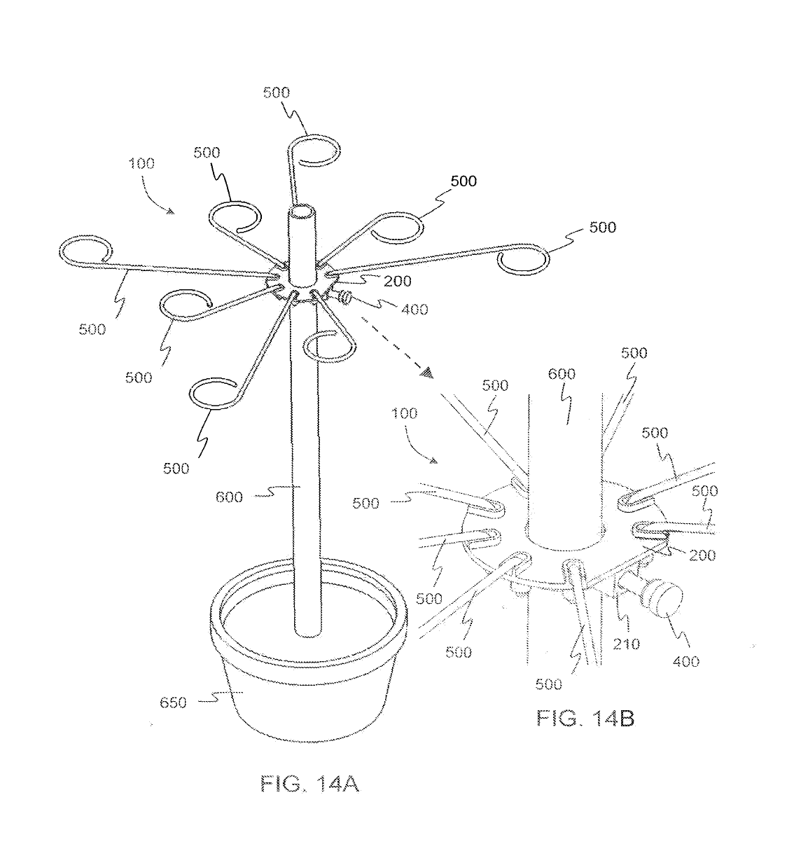

FIG. 14A shows a reconfigurable support system 100, whereby support apparatus 200 of FIG. 2 is coupled to a pole 600 via attachment element 400 and configured with support attachments 500 of FIGS. 5A and 5B. Though FIG. 14A shows pole 600 being “planted” in pot 650, pole 600 also may be planted in any suitable receptacle, or in the ground without a pot or receptacle. Furthermore, pole 600 is shown as an example, and any suitable pole, pipe, stake, of any suitable size, shape, and/or configuration may be implemented. FIG. 14B is an enlarged portion of FIG. 14A showing the support apparatus 200 of FIG. 2 coupled to the pole 600.

As can be understood from FIGS. 14A and 14B, in various embodiments, support apparatus 200 can be slide over and down pole 600 (or under and up) to a desired location (i.e., height), and attachment element 400 can be adjusted so that it acts directly or causes another member to act on pole 600 to secure the support apparatus 200 at the desired position. For example, in the case of attachment element 400 being a screw, the screw may be tightened such that it abuts pole 600 and secures the support apparatus 200 in place. Support attachments, as disclosed herein may be inserted into respective apertures 204 and optional boss members 206. Support attachments may be coupled to support apparatus 200 before and/or after coupling to pole 600. In various embodiments, support apparatus 200 may be adjusted up and/or down the pole 600 by adjusting the attachment element 400.

Other examples of support apparatuses and systems thereof according to various embodiments of the disclosed subject matter will now be described.

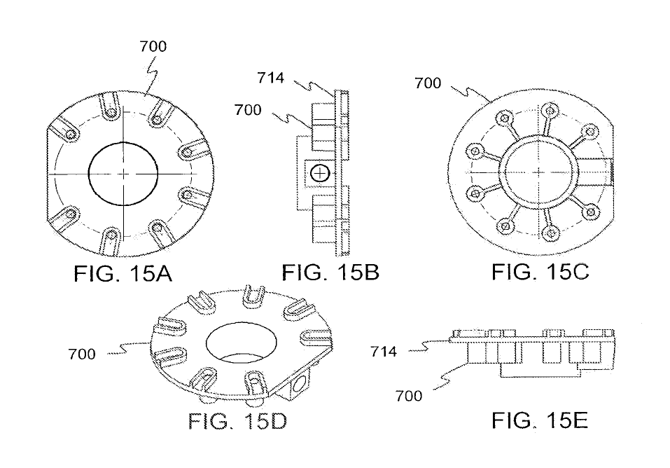

FIGS. 15A, 15B, 15C, 15D, and 15E are overhead, front, bottom, perspective, and side views, respectively, of a support apparatus 700 similar to the support apparatus 200 shown in FIG. 2, according to various embodiments of the disclosed subject matter. Support apparatus 700 is different from support apparatus 200 in that flange 714 is not angled upward by an angle θ (i.e., angle θ equals zero). Support apparatus 700 may be compatible with attachment elements as described herein or variations thereof, such as attachment element 400. Support apparatus 700 also may be compatible with support attachments as described herein or variations thereof, such as support attachments 500, 510, and/or 520. Optionally, support apparatus 700 may be fitted with an insert element, such as insert element 300.

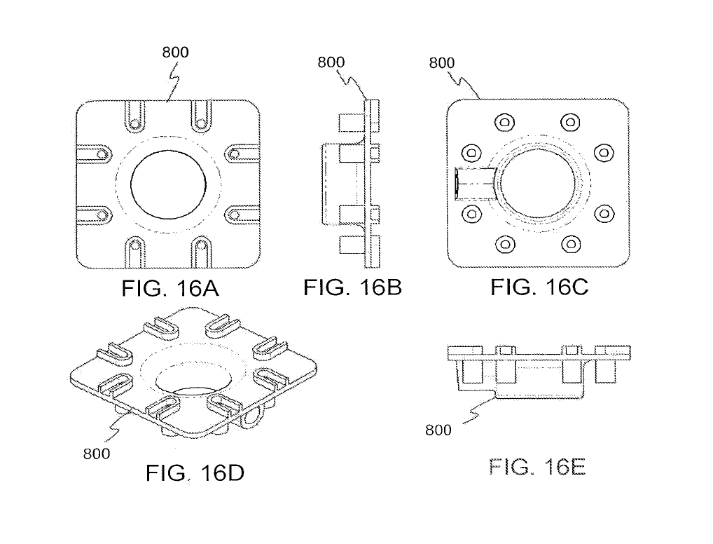

FIGS. 16A, 16B, 16C, 16D, and 16E are overhead, back, bottom, perspective, and side views, respectively, of a support apparatus 800 having a generally square shape flange in plan view according to various embodiments of the disclosed subject matter. Support apparatus 800 may be compatible with attachment elements as described herein or variations thereof, such as attachment element 400. Support apparatus 800 also may be compatible with support attachments as described herein or variations thereof, such as support attachments 500, 510, and/or 520. Optionally, support apparatus 800 may be fitted with an insert element, such as insert element 300.

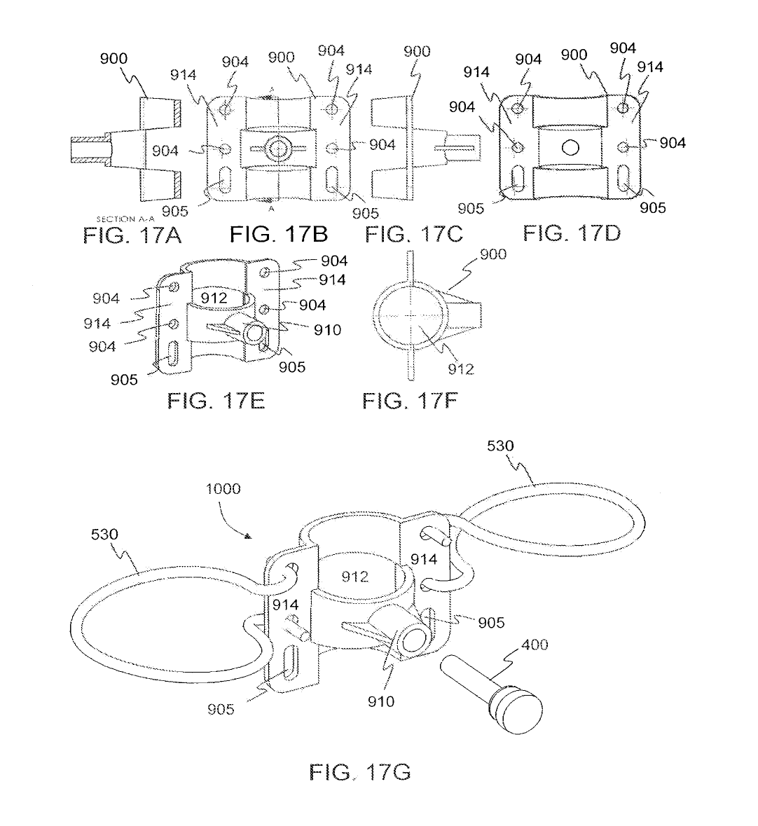

FIGS. 17A, 17B, 17C, 17D, 17E, and 17F are cross-sectional, front, side, back, perspective, and end views, respectively, of a support apparatus 900 according to various embodiments of the disclosed subject matter. FIG. 17G is a perspective view of a reconfigurable support system 1000 according to various embodiments of the disclosed subject matter, comprised of the support apparatus 900 configured with support attachments 530 and an attachment element 400.

Generally speaking, support apparatus 900 can be slide over and down (or under and up) pole 600 to a desired location (i.e., height), and attachment element 400 can be adjusted so that it acts directly or causes another member to act on pole 600 to secure the support apparatus 900 at the desired position. In the case of attachment element 400 being a screw, for example, the screw may be tightened such that it abuts a pole, pipe, or stake and secures the support apparatus 900 in place. Attachment element 400 can be adjusted so that the support apparatus 900 can be moved up and/or down to different positions on the pole, pipe, or stake. In various embodiments, a size and/or shape of an internal volume 912 of the support apparatus 900 may be based on the size and/or shape of a pole, stake, or pipe, such as pole 600, to which support apparatus 900 is to be mechanically coupled. Optionally, support apparatus 900 may be fitted with an insert element, such as insert element 300, to fit a size and/or shape of a pole, stake, or pipe.

One or more support attachments may be coupled and/or recoupled to opposing vertical flanges 914 by way of apertures 904 and/or 905. Support attachments can be any suitable support attachment, such as support attachments 530 (as shown) or other wiring, strings, straps, zip ties, etc. Apertures 904, 905 can be of any suitable number, of any suitable shape and/or size, and of any suitable arrangement on vertical flanges 914. Aperture size, shape, arrangement, and/or number may or may not be the same for each vertical flange 914.

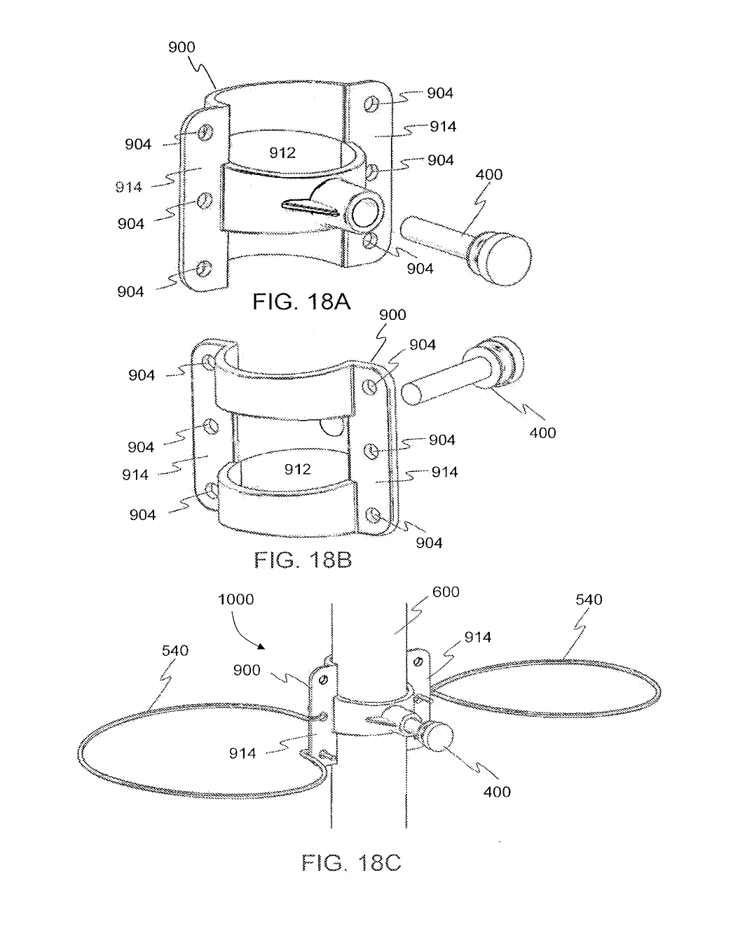

FIGS. 18A and 18B, for example, show support apparatus 900 similar to support apparatus of FIGS. 17A through 17F, but without a third elongate aperture. FIG. 18C shows reconfigurable support system 1000 with the support apparatus of FIGS. 18A and 18B configured with support attachments 540 and mechanically coupled to a pole 600 by attachment element 400. Support attachments 540 may or may not be the same as support attachments 530. As with the support apparatus shown in FIGS. 17A through 17F, support apparatus 900 shown in FIGS. 18A and 18B optionally may be fitted with an insert element, such as insert element 300, to fit a size and/or shape of a pole, stake, or pipe.

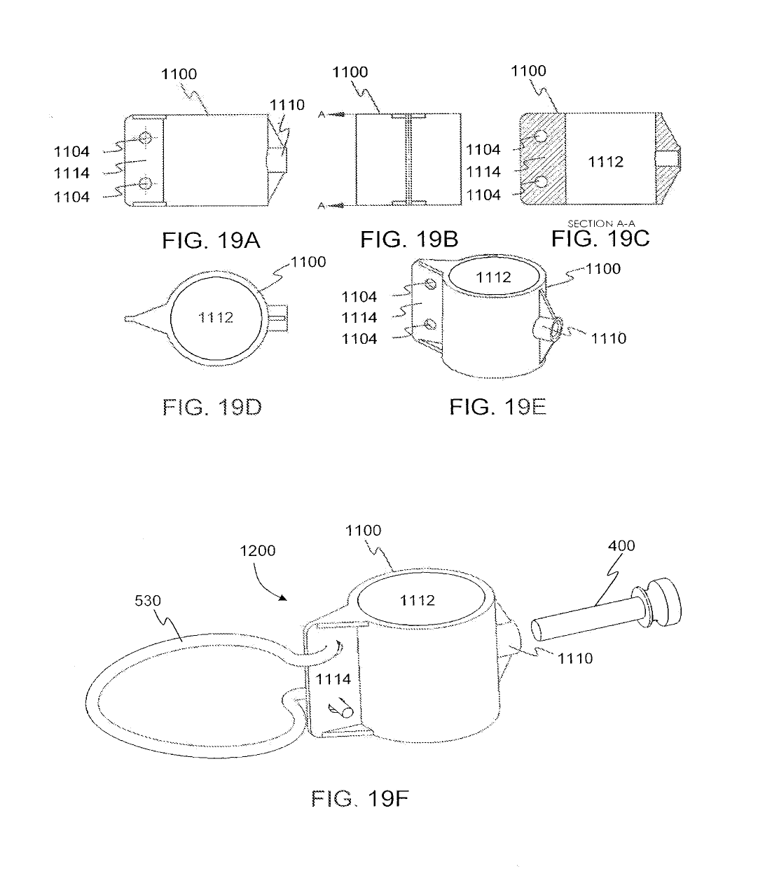

FIGS. 19A, 19B, 19C, 19D, and 19E are side, back, cross-sectional, end, and perspective views, respectively, of a support apparatus 1100 according to various embodiments of the disclosed subject matter. FIG. 19F is a perspective view of a reconfigurable support system 1200 according to various embodiments of the disclosed subject matter comprised of the support apparatus 1100 configured with a support attachment 530 and an attachment element 400.

Generally speaking, support apparatus 1100 can be slide over and down (or under and up) a pole, stake, or pipe to a desired location (i.e., height), and attachment element 400 can be adjusted so that it acts directly or causes another member to act on the pole, stake, or pipe to secure the support apparatus 1100 at the desired position. In the case of attachment element 400 being a screw, for example, the screw may be tightened such that it abuts the pole, stake, or pipe and secures the support apparatus 1100 in place. Attachment element 400 can be adjusted so that the support apparatus 1100 can be moved up and/or down to different positions on the pole, stake, or pipe. In various embodiments, a size and/or shape of an internal volume 1112 of the support apparatus 1100 may be based on the size and/or shape of a pole, stake, or pipe to which support apparatus 1100 is to be mechanically coupled. Optionally, support apparatus 1100 may be fitted with an insert element, such as insert element 300, to fit a size and/or shape of a pole, stake, or pipe.

One or more support attachments may be coupled and/or recoupled to vertical flange 1114 by way of apertures 1104. Support attachments can be any suitable support attachment, such as support attachments 530 or other wiring, strings, straps, zip ties, etc. Apertures 1104 can be of any suitable number, of any suitable shape and/or size, and of any suitable arrangement on vertical flange 1114. Aperture 1104 size, shape, arrangement, and/or number may or may not be the same.

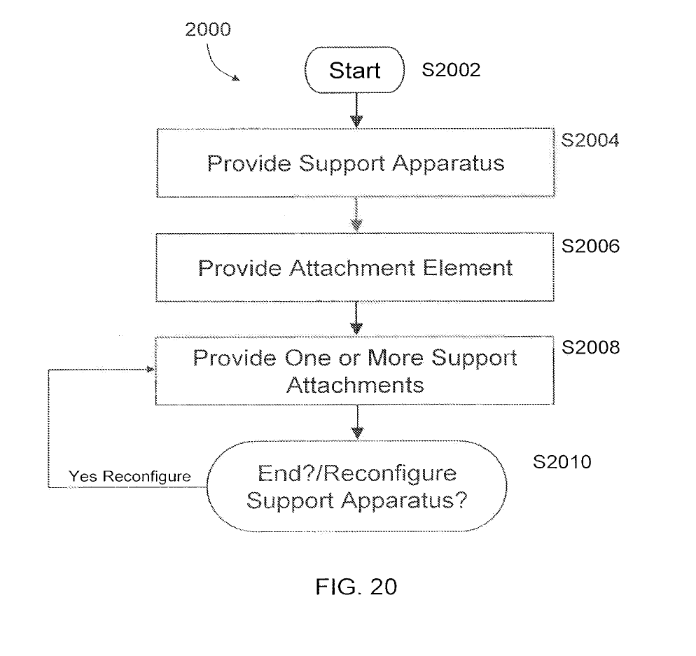

FIG. 20 is a flow chart of a method 2000 according to various embodiments of the disclosed subject matter.

Method 2000 can begin at S2002 and proceed to S2004, whereby a support apparatus as described herein can be provided. In various embodiments, S2004 can include providing a support apparatus by sliding the support apparatus over and down (or under and up) a pipe, pole, or stake. The pipe, pole, or stake may or may not be planted at this time.

At S2006, an attachment element as described herein can be provided. S2006 can include providing an attachment by adjusting the attachment element so that it acts to support the support apparatus at a desired position on the pipe, pole, or stake, or to mechanically couple the support apparatus to the pipe, pole, or stake at a desired position. For example, a thumb screw may be inserted into a receiving portion of the support apparatus and tightened against the pipe, pole, or stake so that the support apparatus remains in a fixed position along the pipe, pole, or stake.

At S2008, one or more support attachments as described herein may be provided by being physically coupled to the support apparatus.

The method 2000 may end at S2010. Or, if the support apparatus is to be reconfigured with a different support attachment configuration, the method may loop back to S2008.

Optionally, portions of plants, such as plant sterns, may be placed within, on, or about the one or more support attachments for support thereof. In various embodiments, the support attachment may be repositioned to a different position on the pipe, pole, or stake. Optionally, in various embodiments, an arrangement of support attachments may be reconfigured.

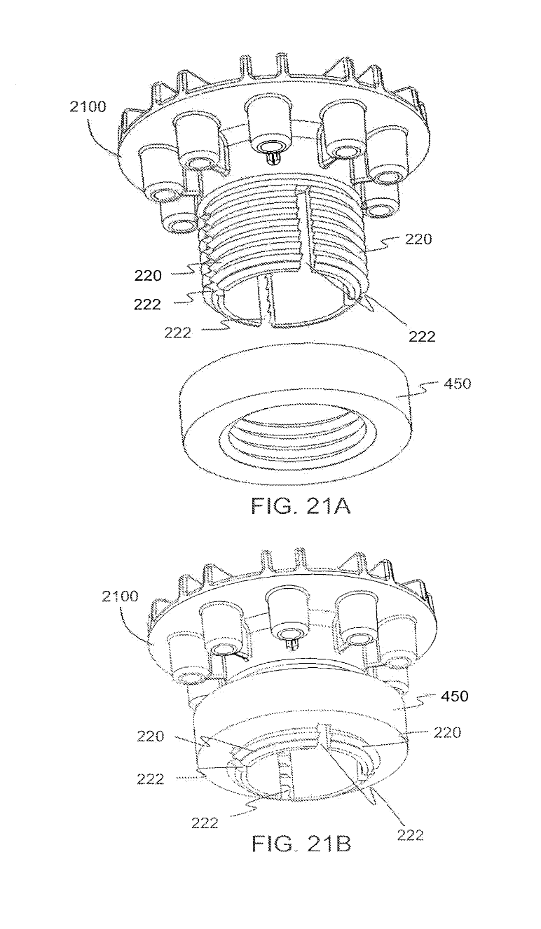

FIG. 21A is an underneath exploded view of a support apparatus 2100 and collet 450 according to various embodiments of the disclosed subject matter. FIG. 21 B is an underneath view of the support apparatus 2100 collet 450 shown in FIG. 21A. Support apparatus 2100 may have a threaded portion with slots 222 and tangs 220 to receive a threaded collet 450. The threaded portion-collet combination can be used to secure the support apparatus 2100 to a pole, pipe, or stake. For example, threaded collet 450 is threaded upward along the threaded portion of the support apparatus 2100 to make the tangs close radially inward so as to press against a pole, pipe, or stake.

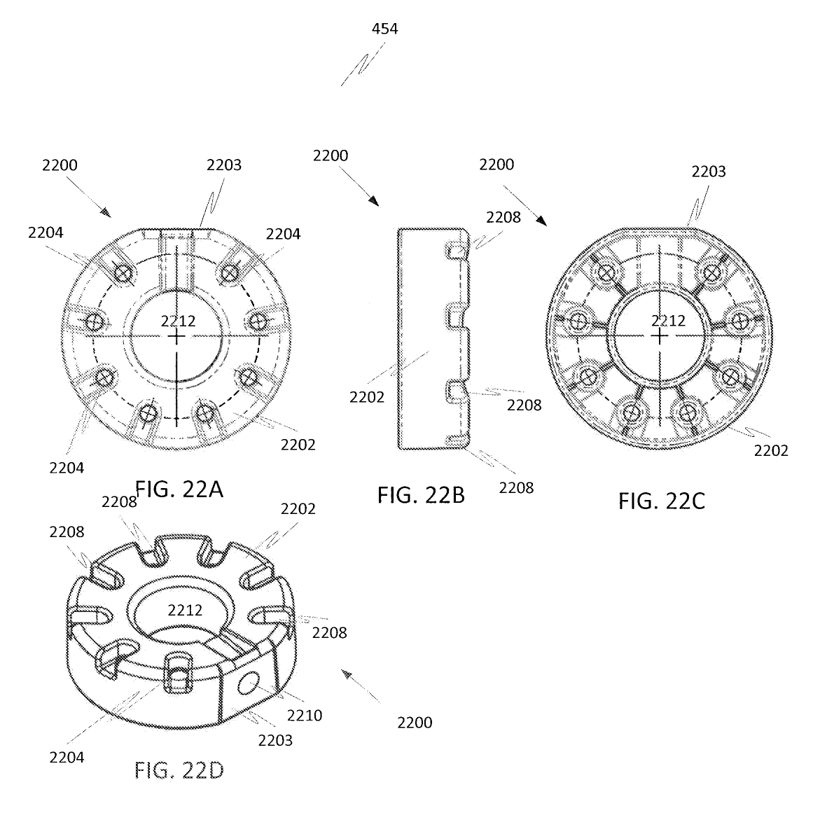

FIGS. 22A-22D show another embodiment of a support apparatus in the form of a collar 2200.

Collar 2200 can have a generally annular body 2202 with a circular or generally circular outer perimeter or circumference in plan view. Optionally, a flat portion 2203 in plan view may be provided. Flat portion 2203 may facilitate access to a receiving portion 2210 configured to receive an attachment element according to various embodiments of the disclosed subject matter. Optionally, flat portion 2203 may also facilitate access to the attachment element itself (e.g., it may facilitate removal and/or installation of the attachment element). Annular body 2202 also may have an open portion 2212, which can take any suitable shape in plan view, such as circular, square, rectangle, oval, etc. In various embodiments, the shape of open portion 2212 may correspond to a shape of a pole, stake, or pipe to which the support apparatus is to be coupled. Furthermore, optionally, a portion of annular body 2202 surrounding open portion may be at an angle or taper from a top to a bottom of annular body 2202 or vice versa. Alternatively, in various embodiments, a portion of the annular body 2202 surrounding open portion 2212 may be threaded.

Annular body 2202 can have a plurality of apertures 2204 formed therein (for each of viewing the figures, all of the apertures 2204 have not been labeled). In various embodiments, apertures 2204 can be receptacles for removably coupling support attachments to collar 2200 according to various embodiments of the disclosed subject matter. Support attachments may be retained in respective apertures 2204 by friction and gravity and/or by being passed through the aperture and tied thereto (e.g., in the case of a tie string as a support attachment).

In various embodiments, each of the apertures 2204 can extend through the annular body 2202 in a direction parallel to the imaginary longitudinal center axis of open portion 2212. Optionally, annular body 2202 can also include a plurality of boss members 208 in correspondence with respective apertures 2204. Boss members 2208 can provide support and/or stability for support attachments placed therein. Optionally or alternatively, one, some, or all of the apertures 2204 can extend through the annular body 2202 at a non-parallel angle or at different non-parallel angles to the imaginary longitudinal center axis of open portion 2212. In various embodiments, all of the apertures 2204 can be at the same non-parallel angle. Alternatively, all of the apertures 2204 may be at different angles, or some of the apertures 2204 may be at the same angle. The orientation of the apertures 2204 in the annular body 2202 may be based on a configuration of the support attachments to be mechanically attached or coupled to the collar 2200. Furthermore, the orientation of the apertures 2204 may provide support or stabilization for support attachments that are mechanically attached or coupled to collar 2200.

Apertures 2204 can be of any suitable number, of any suitable shape and/or size, and of any suitable arrangement about annular body 202. FIGS. 22A-22D, for example, show eight cylindrical apertures 2204, radially arranged about annular body 2202. An equal distance between some or all adjacent apertures 2204 may be provided in various embodiments. Furthermore, apertures 2204 may be arranged about annular body 2202 to provide a configurable or reconfigurable range of support, such as 360 degrees or less than 360 degrees.

As noted above, in various embodiments, support attachments may be retained in respective apertures 2204 by friction and gravity. Though not shown, individual caps, covers, or push nuts, for example, may be placed over individual boss members 2208 in order to prevent support attachments from being removed. Individual caps or covers may be coupled to their respective boss members 2208, for example, by a hinge or tether. Alternatively, a single cap or cover may be provided to cover all of the boss members 2208 to prevent all support attachments from being removed. The single cap or cover also may be coupled to the collar 2200 by either a tether or a hinge, for example. In various embodiments, each support attachment also may be retained in the apertures 2204 and/or boss members 2208 from an underside of the collar 2200 by a cap or washer or the like, for example, placed on an end of the support attachment protruding from the aperture 2204 and boss 2208, on an underside of the collar 2200.

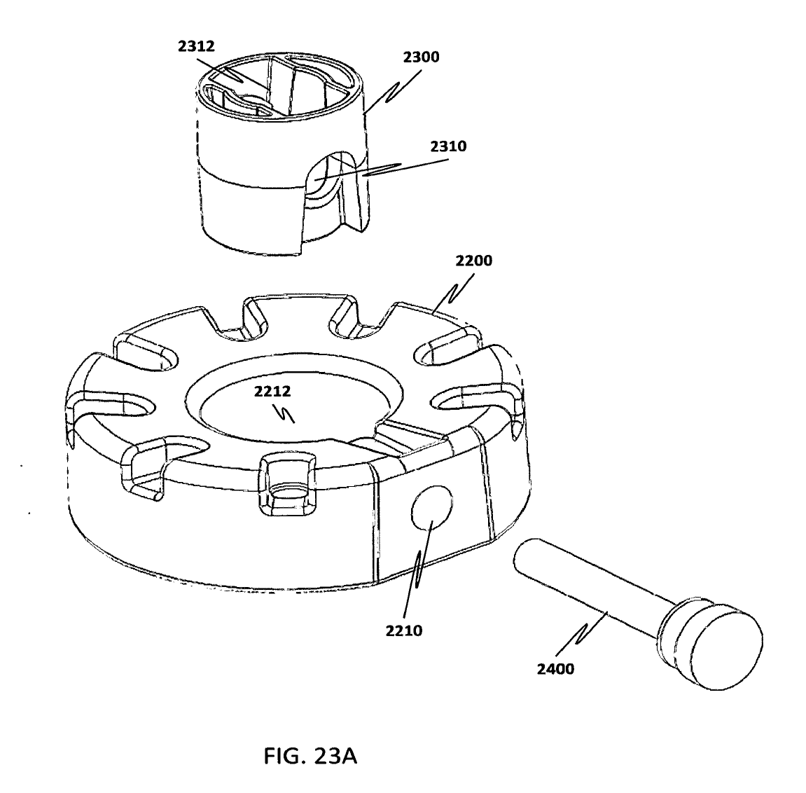

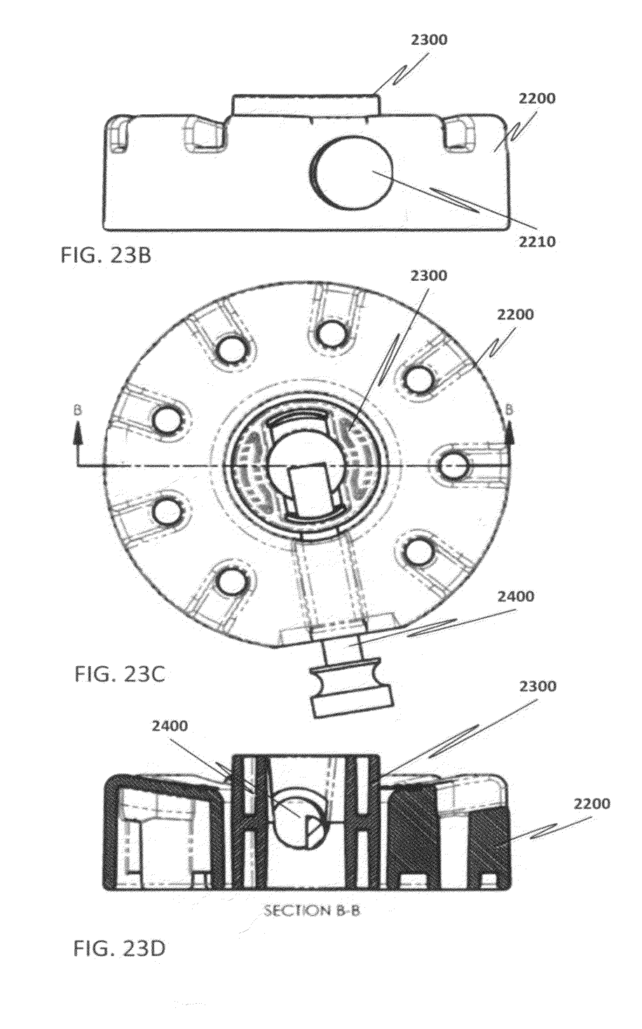

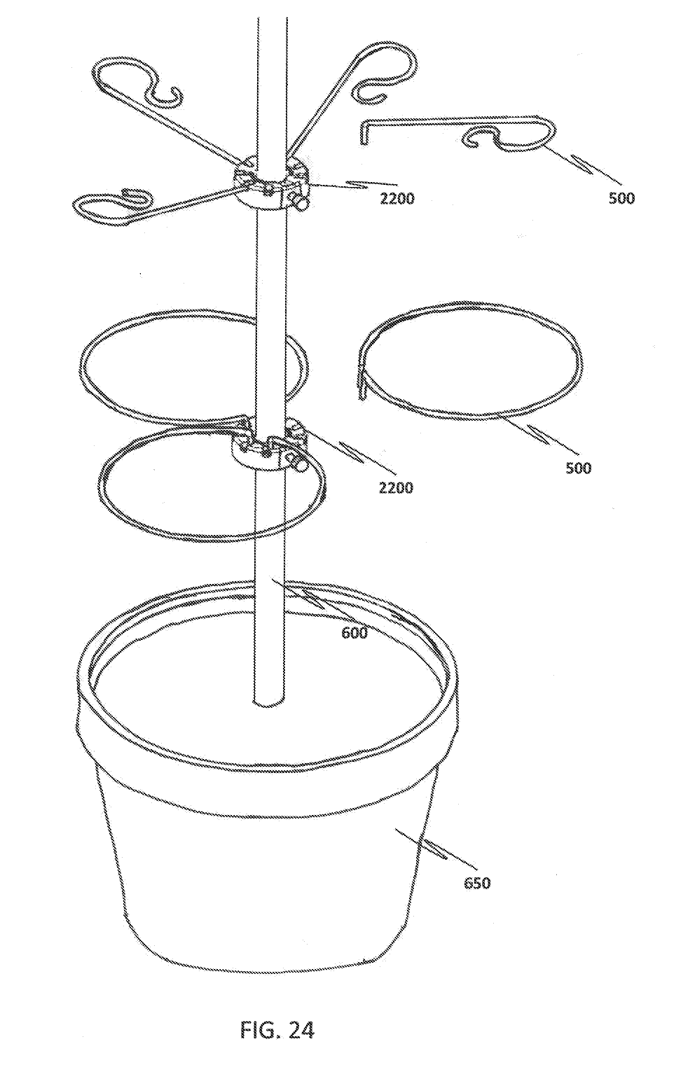

In various embodiments, collar 2200 can include a receiving portion 2210. Receiving portion 2210 can be provided to receive an attachment element 2400 for physically coupling the collar 2200 to a planting pole, stake, or pipe, for example. FIGS. 23A and 23C show an example of an attachment element 2400 in the form of a screw, which can be of any suitable configuration, such as a thumb screw (threads not explicitly shown).

Receiving portion 2210 can be of any suitable configuration. In various embodiments, receiving portion 2210 can be configured based on a configuration of an attachment element 2400 to be received. For example, receiving portion 2210 may be threaded (not explicitly shown in the figures) to receive a screw and to allow the screw to be threaded to extend into open portion 2212 to change a volume of the open portion. Such changing of volume of the open portion 2212 can be performed in order to “fit” the collar 2200 to different sizes of planting poles, pipes, or stakes. Another example of a configuration of the receiving portion 2210 includes a plurality of notches linearly arranged along a length of the inner cavity thereof, for example, to receive a corresponding depressible notch of attachment element 2400 in order to set the attachment element 2400 at different positions in the receiving portion 2210 and/or in the open portion 2212. Conversely, an attachment element 2400 according to various embodiments of the disclosed subject matter can be configured based on the configuration of the receiving portion 2210.

The inner portion of collar 2200 (i.e., the outer portion of the open portion 2212) can be of any shape, size, and/or configuration. For example, the size (e.g., diameter), shape, and/or configuration can be based on a size, shape, and/or configuration of a pole, pipe, or stake to which the collar 2200 is to be mechanically coupled. The inner portion of collar 2200 can run parallel to a central longitudinal axis of the inner portion, or, optionally, it can be angled, tapered, or some combination of parallel and non-parallel portions. in various embodiments the inner portion of collar 2200 can be angled (e.g., either tapered from top to bottom or vice versa) so that the collar 2200 can be removed from a molding tool.

Optionally, in various embodiments, an insert element 2300 may be provided in order to effectively change an inner diameter or volume of collar 2200 to an inner volume 2312 of the insert element 2300, for example, in order to fit different sizes of pipes, poles, or stakes. Insert element 2300 can be of any suitable configuration and of any suitable size and/or shape. FIGS. 23A-22D, for example show a generally cylindrical insert 2300 having an inner volume 2312 and with an opening 2310 that is to be lined up with an opening of the receiving portion 2210 when the insert element 2300 is inserted into the open portion 2212 of the collar 2200.

As indicated above, one or more annular collars 2200 can be secured to a variety of plant pipes, poles, and/or stakes, for example. In various embodiments, the annular collar 2200 can be secured to a plant pipe, pole, or state using an attachment element 2400, such as a screw. Optionally or alternatively, the annular collar 2200 may rest at an appropriate height, based on its inner diameter, along a pipe, a pole, or a stake having a width or diameter that increases from top to bottom. Thus, in the aforementioned embodiment, an attachment element as shown and described with respect to item 2400 above may not be necessary for the collar to be “held” in place. Alternatively, the plant pipe, pole, or stake may be itself threaded and the annular collar 2200 may have a threaded inner portion for mating with the threads of the pipe, pole, or stake. Thus, the annular collar 2200 in this particular embodiment can be threaded upward and/or downward along a length of the pipe, pole, or stake in order to adjust a height at which the collar 2200 rests. A locking mechanism also may be implemented to lock the collar 2200 at a particular position on the threaded pipe, pole, or stake.

One or more support attachments 500 can be coupled to the support apparatus 2200 and can extend generally radially outward from the support apparatus 2200. The one or more support attachments 500 can provide support for an associated plant or plants in proximity thereto. Optionally, some or all of the support attachments can provide support by allowing various parts of the plant to rest or lean thereon. Optionally or alternatively, some or all of the support attachments can be coupled to parts of the plants, such as the stems.

While the disclosed subject matter has been described in conjunction with a number of embodiments, it is evident that many alternatives, modifications and variations would be or are apparent to those of ordinary skill in the applicable arts. Accordingly, Applicant intends to embrace all such alternatives, modifications, equivalents, and variations that are within the spirit and scope of the disclosed subject matter described herein.

What is claimed is:

1. A support collar for supporting a plant comprising:
an annular body having an outer circumference in plan view and defining a hollow inner portion;
a receiving portion to receive an attachment element;
a plurality of apertures extending through the annular body, from a top side to a bottom side thereof; and
a plurality of boss elements, each said boss element being associated with a respective one of said apertures and configured to restrict at least lateral movement of a portion of a support attachment when the support attachment is inserted in the associated aperture.

2. The plant collar according to claim 1, wherein the outer circumference of the annular body is generally circular in plan view, and the hollow inner portion is circular in shape in the plan view.

3. The plant collar according to claim 1, wherein the outer circumference of the annular body is generally square shape in plan view, and the hollow inner portion is circular in shape in the plan view.

4. The plant collar according to claim 1, wherein each said boss element substantially prevents lateral movement of the portion of the support attachment when the support attachment is fully seated.

5. The plant collar according to claim 1, wherein the annular body has a flange portion extending from hollow inner portion to the outer circumference, the flange portion being formed at an angle with respect to a horizontal plane perpendicular to an imaginary longitudinal center axis of the annular body.

6. The plant collar according to claim 5, wherein the angle is an acute angle.

7. The plant collar according to claim 5, wherein the angle is zero.

8. The plant collar according to claim 1, wherein each said boss element is one of U-shape, V-shape, digital U-shape, or two spaced-apart I shape members in plan view.

9. The plant collar according to claim 1, wherein each said boss element is recessed in the annular body.

10. The plant collar according to claim 1, wherein the aperture/boss element combinations are arranged radially about the annular body.

11. A reconfigurable system for supporting a plant comprising:
means for supporting at least one plant;
means for receiving said means for supporting; and
means for coupling said means for receiving to one of a planting stake, a planting pole, and a planting pipe.

12. The system of claim 11, wherein said means for supporting includes at least one of a wire, a zip tie, twine, multiple wires, a strap, and a string.

13. The system of claim 11, wherein the system is reconfigurable, reconfigurable including at least one of movement of said means for receiving along a length of the planting stake, a planting pole, and a planting pipe and a different configuration of said means for supporting at least one plant.

14. The system of claim 11, further comprising means for restricting or inhibiting movement of said means for supporting at least one plant.

15. The system of claim 11, wherein said receiving said means for supporting includes:
means for receiving said means for coupling;
a plurality of apertures extending in a thickness direction thereof; and
means for restricting or inhibiting movement of said means for supporting at least one plant.

16. The system of claim 11, further comprising means for changing an inner volume or diameter of said means for receiving said means for supporting.

17. The system of claim 11, wherein said means for supporting at least one plant includes a plurality of individual support members.

18. A method for supporting a plant comprising:
providing an annular collar;
providing an attachment element, the attachment element coupling the annular collar to one of a planting stake, a planting pole, and a planting pipe; and
providing at least support attachment, said providing including physically configuring the annular collar with at least one support attachment.

19. The method of claim 18, further comprising physically reconfiguring the annular collar with one or more support attachments.

20. The method of claim 19, wherein said physically reconfiguring the annular collar is with one or more support attachments different from said at least one support attachment of said physically configuring.
